(19) United States
(12) Patent Application Publication
(10) Pub. No.: US 2011/0139764 A1
(43) Pub. Date: Jun. 16, 2011

(54) Chafing Dish

(76) Inventors: Connie Pezulich, Brooklyn, NY (US); Jack Abbate, Chester, NY (US)

(21) Appl. No.: 12/638,352

(22) Filed: Dec. 15, 2009

(51) Int. Cl. A47J 39/02

(52) U.S. Cl. 219/436

(57) ABSTRACT

A portable article of heating apparatus comprising a heat-insulating lower base member and a separate heat-conducting and heat-retaining upper plate member. The lower base member comprises a top surface, a bottom surface, and at least one side, with the top surface comprising a recess designed to receive the separately-heated upper plate member for the purposes of efficient and mobile heating of food containers.

The present invention relates generally to an article of heating apparatus, and, in particular, an article of heating apparatus structured and arranged to more efficiently heat and better maintain the temperature of food vessels, and to add flexibility to the potential uses of articles of heating apparatus.

### BACKGROUND OF THE INVENTION

Hot plates and chafing dishes are widely used for buffet-type foodservices and other food service-related purposes. Chafing dishes typically include a water pan. A heat source is used to directly heat water in the water pan of a chafing dish. In the case of a hot plate, the heat source is used to heat the plate surface upon which food containers are placed.

Chafing dishes utilize a heat source either from canned fuels or from an electrical mechanism. Hot plates typically use an electrical heat source. Whether the heat emanates from an electrical heat source or a flame, the heat is used to raise and maintain the temperature of food in a container that either sits in a water container or that sits directly on a hot plate.

Chafing dishes often use canned fuels as their flame source. The canned fuel ordinarily used is an alcohol-based fuel such as Sterno® (Sterno Group LLC, 1 East Weaver Street, Greenwich, Conn. 06831; U.S. Reg. No. 0105426).

Canned fuel flames are unreliable, costly, take up unnecessary storage space, and are generally environmentally-unfriendly. Canned fuel flames often interrupt when the fuel changes state from liquid to gas, causing the flame source to suffer from flame-size variations, uneven heat production, and sometimes the flame distinguishing altogether when the fuel vaporizes. Such unreliability is unacceptable in a fast paced food-services environment.

Moreover, canned heat sources are costly. Fuel cans need to be constantly replaced before service to prevent heat and service disruption, and, over time, the cost of fuel can replacements make such articles of heating apparatus economically unfeasible. It is also, for obvious reasons, undesirable to subject food-service establishments to such guaranteed long term costs. Canned-heat arrangements also often require intricate fuel holders and other mechanisms that require servicing and maintenance, and which also detract from the robustness and effectiveness of the heating apparatus.

Finally, fuel cans and often, canned fuel holders, must be disposed after use, causing unnecessary wastage and harm to the environment. The fuel residue from the cans is harmful to the environment and the general waste from the disposal of such items makes such articles of heating apparatus a generally environmentally-unfriendly choice for food-service establishments.

Electrically-heated hot plates and similarly-heated chafing dishes suffer from similar structural problems. Electrically-heated hot plates possess electrical power inlets and therefore rely on a power source. As a result, they are mostly immobile when in use, limiting the flexibility of their service capabilities. Electrically-heated chafing dishes suffer from similar problems. Aside from lack of mobility, they invariably utilize thermostatic controls that can prove to be costly, unreliable, and of limited durability. Electric heater elements for chafing dishes also require servicing of any parts of such units that are positioned in close proximity to the water in any water pan.

Finally, if any material part of the electrical-heater element of either a hot plate or a chafing dish fails or otherwise becomes damaged, the entire electrical hot plate/chafing dish is rendered unusable and must be fixed, replaced, or otherwise disposed. Such unpredictability and potentially sudden unavailability of use is unacceptable where customer service depends on the good working order of food-heating appliances. Short-lived heating devices also result in additional waste and unnecessary environmental harm.

In short, the prior art has been found to not provide consistent, reliable, durable, and environmentally-friendly heat sources with enough flexibility and mobility for the important needs of the food service industry. It is therefore desirable to provide an article of heating apparatus that provides a new and improved structure for the heating of food, and which can do so with greater reliability and mobility.

### SUMMARY OF THE INVENTION

Accordingly, it is an object of this invention to provide a new and improved article of heating apparatus that is structured and arranged to provide a heat source that is not reliant on flame systems from canned fuels or electrical power sources, and which also provides greater mobility to articles of heating apparatus.

Specifically, it is an object of the present invention to provide a new and improved article of heating apparatus for food in the form of a heat-absorbing and heat-retaining detachable plate and a corresponding heat-insulating base, to more reliably and efficiently heat and maintain the temperature of food containers placed upon the article of heating apparatus.

It is a further object of the present invention to provide an article of heating apparatus that offers new and improved flexibility and mobility to the serving of food, and which is environmentally-friendly.

Briefly, in accordance with the present invention, these and other objects are achieved by providing an article of heating apparatus comprising a detachable heat-conducting and heat-retaining upper plate member or hot plate, and which further comprises a heat-insulating base designed to receive the hot plate. The present invention is not reliant on flame systems from canned fuels or electrical systems from electrical power sources, providing greater mobility to the article of heating apparatus. The present invention is also more durable than the prior art, resulting in less waste, and, therefore, harm to the environment.

The present invention is a novel improvement over the prior art because while the prior art teaches many different varieties of heating apparatus for food, none of the prior art teaches an article of heating apparatus that is structured and arranged to be heated by an oven, and which can be moved away from immobile power sources, i.e. electrical outlets.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a side elevation view of an article of heating apparatus in accordance with the present invention;

FIG. 2 is a side elevation view of the article of heating apparatus shown in FIG. 1, with the upper plate member and lower base member separated;

FIG. 3 is a bottom plan view of the lower base member of the article of heating apparatus shown in FIGS. 1 and 2;

FIG. 4 is a side view of the lower base member of the article of heating apparatus shown in FIGS. 1, 2 and 3;

FIG. 5 is a side elevation view of the lower base member of the article of heating apparatus shown in FIGS. 1, 2, 3 and 4, with the upper plate member not visible;

FIG. 6 is a top plan view of the upper plate member of the article of heating apparatus shown in FIGS. 1, 2, 3, 4 and 5; and

FIG. 7 is a bottom plan view of the upper plate member of the article of heating apparatus shown in FIGS. 1, 2, 3, 4, 5 and 6.

### DETAILED DESCRIPTION OF THE INVENTION

The hot plate is structured and arranged to conduct heat when placed in an oven or similar heating unit. It can then be housed in the base and used to heat food vessels placed upon it. Additional hot plates can be used to replace the original hot plate when the heat diminishes to maintain the temperature of food.

The present invention primarily comprises two portions, a lower base member and an upper plate member, both of which are circular shaped. The lower base member comprises a top surface, a bottom surface, and at least one side.

The top surface of the lower base member comprises a recess designed to receive and house the upper plate member. The lower base member has four stabilizing members protruding from its bottom surface.

The upper plate member has a top surface and a bottom surface. The top surface comprises a number of circular recesses. The bottom surface preferably does not feature any such recesses. The upper plate member has a diameter less than that of the recess on the lower base member to allow the upper plate member to fit in the recess.

The upper plate member is preferably made of a heat conducting and heat retaining material, such as basalt, but can also be made of metal, aluminum, alloy, granite, rhyolite, andesite, komatiite, diorite, gabbro, reidolite, diabese. When placed in an oven, or some other similar heat source, the upper plate member conducts and retains heat to raise and maintain the necessary temperature of hot food items placed upon it. The upper plate member is further structured and arranged to provide a slip-resistant surface to more efficiently grip food containers placed upon it.

The lower base member preferably comprises a heat-insulating interior such as fiberglass, ceramic, acetate, acrylic, delrin, glass, mica, nomex, polystyrene, polyurethane, polyvinylchloride, silicone, Teflon® (E. I. Du Pont De Nemours & Co., 1007 Market Street, Wilmington, Del. 19898; Reg. No.: 1592650) , thermoplastic, insulating foam, vinyl or laminates, and preferably comprises a strengthening and heat-insulating coating or covering such as resin substances, such as copal, dammar, mastic, or sandarac, or glass, acrylic, Perspex® (Imperial Chemical Industries, Ltd., Millbank, London, SW1, England; Reg. No.: 0555324) or Plexiglas® (Rohm & Haas Co., 222 W. Washington Square, Philadelphia Pa.; Reg. No.: 0338539), to allow the heat absorbed by the upper plate member to be retained and harvested towards any food container placed on the article of heating apparatus when the upper plate member is housed in the recess. Of course, because of the above structural components, the article of heating apparatus is not reliant on any electrical power source and is therefore fully mobile.

As illustrated in the Figures, the article of heating apparatus, generally indicated at 1, comprises a lower base member 2 and an upper plate member 3.

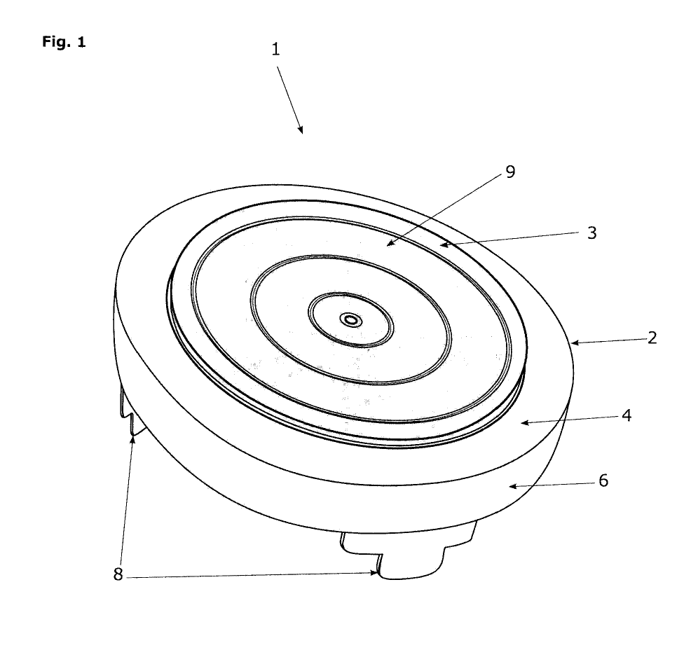

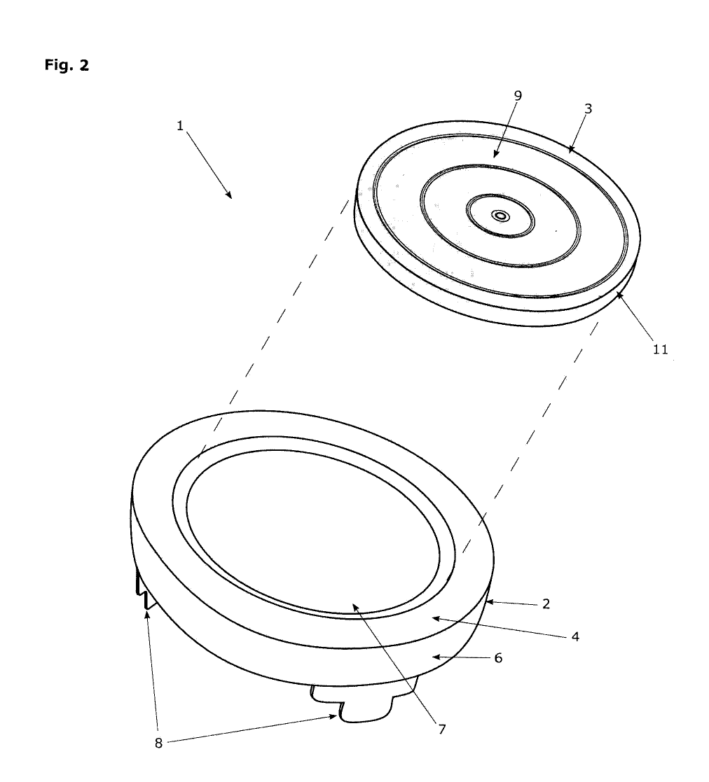

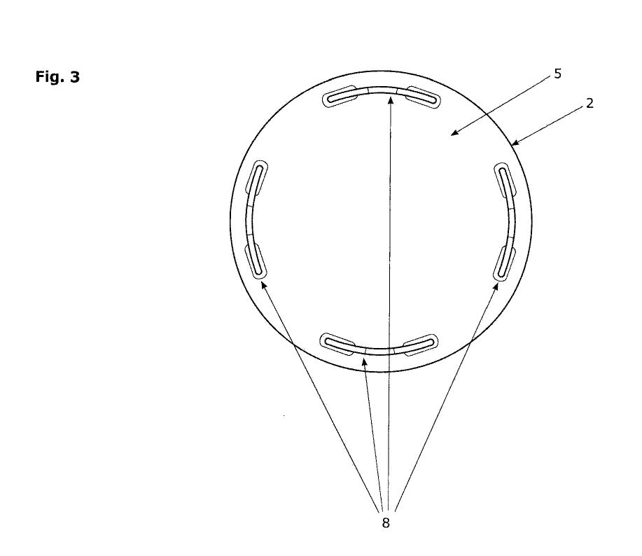

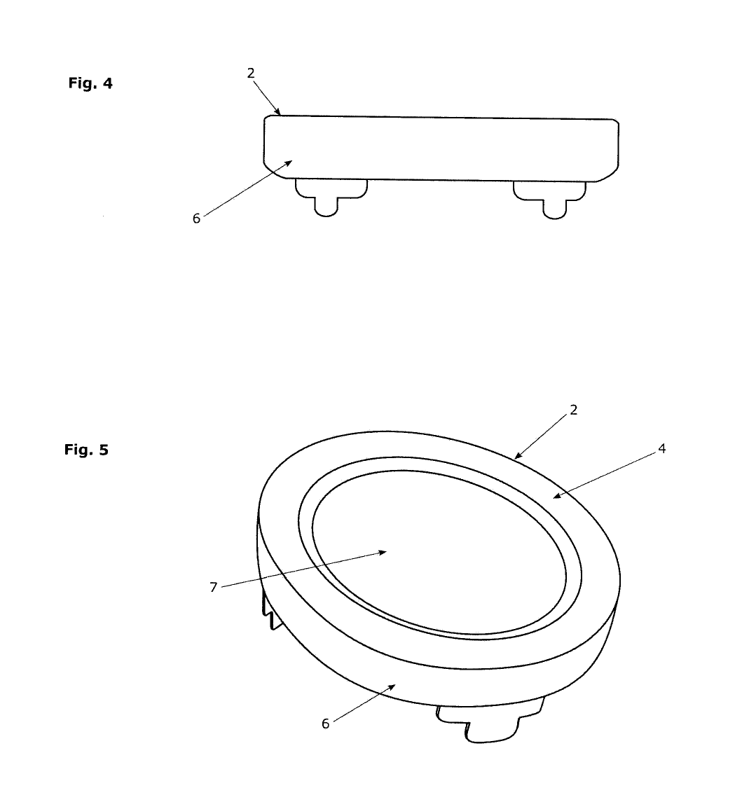

As shown in FIGS. 1, 2, 3 and 5, the lower base member comprises a top surface 4, a bottom surface 5, and at least one side 6. The lower base member 2 is circular shaped.

The lower base member 2 comprises a recess 7 located at the center of the top surface 4, which has a diameter greater than that of the upper plate member 3, and which is structured and arranged to receive and hold in place the upper plate member 3 after the upper plate member 3 has been separately heated, for example by an oven. The lower base member 2 is preferably stabilized on the ground or on food-serving surfaces by four stabilizing members 8 protruding from the bottom surface 5 of the lower base member 2. Each stabilizing member 8 is structured and arranged to sufficiently stabilize the lower base area, each stabilizing member preferably being 2.75 inches wide and 1.25 inches high. The lower base member is preferably 12.25 inches in diameter. The recess 7 is preferably 9.5 inches in diameter. The lower base member can be stabilized with similar embodiments of this design.

The lower base member 2 is preferably coated with stainless steel. The interior of the lower base member 2 is preferably made of a heat-insulating material to maintain the heat emanating from and surrounding the upper plate member 3.

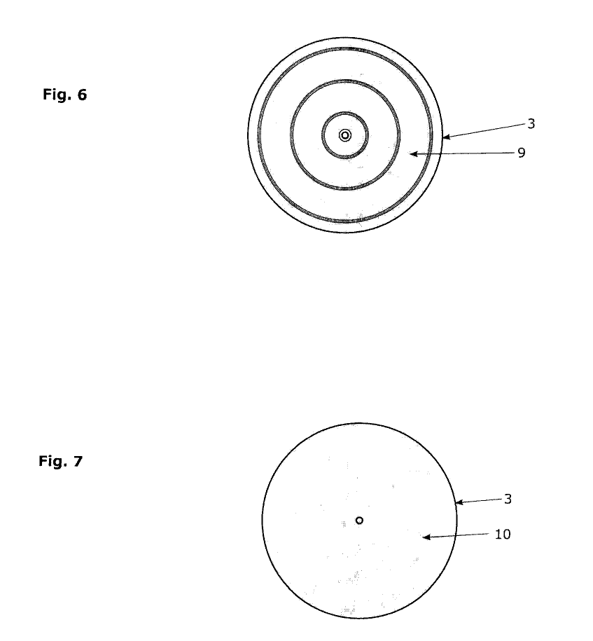

The upper plate member 3 is also circular shaped and has a top surface 9, a bottom surface 10, and at least one side 11. The upper plate member is preferably made of aluminum alloy or a lava stone such as basalt, though it can be made of any other heat-conducting and retaining elements. The upper plate member 3 is preferably 8 inches in diameter, but will have a diameter lesser than that of the lower base member 2, so as to fit as intended in accordance with this invention in the recess 7 of the lower base member 2. As shown in FIGS. 1, 2 and 6, the top surface 8 of the upper plate member 3 comprises several circular recesses preferably located at 0.25 inches, 1.25 inches and 2.5 inches and 3.75 inches from the center of the top surface 8, structured and arranged to support the heating capabilities of the article of heating apparatus. The bottom surface 10 of the upper plate member 3 does not feature any circular recesses that are evident on the top surface 9.

What is claimed is:

1. A portable article of heating apparatus comprising:
a lower base member comprising a top surface, a bottom surface, and at least one side, and
a separate upper plate member comprising a heat-conducting and heat-retaining material, wherein said top surface of said lower base member comprises a recess designed to receive said upper plate member, and
wherein said lower base member further comprises a heat-insulating interior.

2. The portable article of heating apparatus according to claim 1, wherein said lower base member is circular.

3. The portable article of heating apparatus according to claim 1, wherein said lower base member further comprises stabilizing members protruding from said bottom surface.

4. The portable article of heating apparatus according to claim 3, wherein the lower base member comprises four stabilizing members.

5. The portable article of heating apparatus according to claim 1, wherein said upper plate member has a top surface, a bottom surface, and at least one side.

6. The portable article of heating apparatus according to claim 1, wherein said upper plate member is circular.

7. The portable article of heating apparatus according to claim 1, wherein said upper plate member has a diameter less than the diameter of said recess of said lower base member.

8. The portable heating apparatus according to claim 5, wherein said top surface of said upper plate member further comprises a number of circular recesses.
